(19) United States
(12) Patent Application Publication
(10) Pub. No.: US 2005/0225178 A1
(43) Pub. Date: Oct. 13, 2005

(54) Switching power supply apparatus

(76) Inventors: Geliang Shao, Saitama (JP); Kiyoshi Obikata, Saitama (JP); Kimio Yoshimi, Saitama (JP); Kazunori Matsuzawa, Saitama (JP); Masaru Kubota, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/091,705

(22) Filed: Mar. 29, 2005

(30) Foreign Application Priority Data
Mar. 30, 2004 (JP) 2004-99460

(51) Int. Cl. H02J 7/00

(52) U.S. Cl. 307/129

(57) ABSTRACT

A switching power supply apparatus has a plurality of switching power supply circuits. A control IC (IC1) in a switching power supply circuit generates a PWM drive signal and a synchronizing signal, and also generates DC voltage according to a duty ratio of the PWM drive signal. A control IC (IC2) in the other switching power supply circuit is provided with the synchronizing signal from the IC1 via a transformer, and controls based on a PWM drive signal synchronized with the synchronizing signal. Therefore, switching timing completely matches among the plurality of switching power supply circuits.

### CROSS REFERENCES TO RELATED APPLICATIONS

The present invention contains subject matter related to Japanese Patent Application No. JP 2004-99460 filed in the Japanese Patent Office on Mar. 30, 2004, the entire contents of which being incorporated herein by reference.

### BACKGROUND OF THE INVENTION

1. Field of the Invention

The present invention relates to a switching power supply apparatus performing a switching control synchronously among a plurality of switching power supply circuits.

2. Description of the Related Art

When driving a plurality of switching power supply circuits with different frequencies for each switching power supply circuit, the different frequencies causes beat and waviness that appear at an output.

For example, when a common input voltage is applied to a plurality of switching power supply circuits, each of which having an independent drive circuit that controls a switch element, design of each switching power supply circuit becomes effortless. However, a ripple voltage, such as low frequency distortion as a result of interference, is observed at the output in response to a switching frequency of each drive circuit.

Even if switching frequencies are the same among the plurality of switching power supply circuits, the following disadvantage may appear when drive signals for switching are not synchronized among the plurality of switching power supply circuits. That is, in turning on/off a switch element of each switching power supply circuit, noise appears because of unmatched timing for the switching operations, which results in malfunction of the drive circuits and/or instability of control functions.

Furthermore, when the plurality of switching power supply circuits are not isolated electrically, for example, when they are connected to a common ground potential, or when a synchronizing signal is transferred without insulation, noise accompanied by on/off operation of a switch element of one switching power supply circuit may influence the other switching power supply circuit.

Therefore, from the above view point, it is required among the switching power supply circuits to synchronize drive signals and insulate the same electrically among the switching power supply circuits. Specifically, being a reference of timing for providing drive signals, a synchronizing signal needs to be transferred firmly with insulation, thereby protecting a system against noise.

It is known a means using a photo-coupler for example to transfer a synchronizing signal with insulation.

However, synchronous circuits for transferring a synchronizing signal with insulation suffer from the following disadvantages when photo-couplers are applied.

First, photo-couplers have limitation in high speed operation.

For example, a switching frequency in a frequency range mainly from several 10 KHz to several 1000 KHz is used in a switching power supply apparatus. An output power for a synchronizing signal from a control IC is so small that it cannot drive directly the synchronizing signal with the above high frequency as it is. Accordingly, a driver for driving a photo-coupler with high speed may be required as a pre-circuit of the photo-coupler, which leads to increase of power dissipation (consumption) and cost.

Further, a clock signal used as a synchronizing signal is several volts amplitude and is several ns to 100 ns in width. Therefore, photo-couplers operable in reality are limited. For example, they are only used for switching power supply circuits that operates with a low frequency signal.

Second, even when photo-couplers operable with high frequency are procurable, a power supply device for a light detecting circuit (5V power supply device for example) may be further required, which leads to complexity of a circuit design and cost increase.

Third, large current is required for a photo-coupler in order to transfer a synchronizing signal with high speed. Then, noise may occur in a synchronous circuit in response to timing of the drive current.

### SUMMARY OF THE INVENTION

From the above view point, it is desirable to provide a switching power supply apparatus that is excellent in high speed operation, small and low cost.

According to the present invention, there is provided a switching power supply apparatus including: a first switching power supply circuit for performing a switching operation based on a first drive signal; a second switching power supply circuit for performing a switching operation based on a second drive signal; and a synchronous circuit having a transformer, wherein a synchronizing signal, which is a reference signal for the drive signals, is generated in one of the first switching power supply circuit and the second switching power supply circuit, and transferred to the other switching power supply circuit via the transformer.

Specifically, the first switching power supply circuit includes: a first transformer; a first switch element connected in series to a first winding of the first transformer; and a first controlling unit for generating a synchronizing signal and the first drive signal synchronized with the synchronizing signal, and providing the first switch element with the first drive signal, thereby controlling current flow of the first winding of the first transformer, the second switching power supply circuit includes: a second transformer; a second switch element connected in series to a first winding of the second transformer; and a second controlling unit for generating the second drive signal synchronized with the synchronizing signal and providing the second switch element with the second drive signal, thereby controlling current flow of the first winding of the second transformer.

Preferably, the first switching power supply circuit generates the first drive signal synchronized with a first synchronizing signal; the second switching power supply circuit generates the second drive signal synchronized with a second synchronizing signal which differs from the first synchronizing signal; and the synchronous circuit has a signal converter for converting the first synchronizing signal to the second synchronizing signal.

Preferably, a winding ratio of the first and second winding of the transformer is adjusted so that desired amplitude of the second synchronizing signal is obtained.

According to the present invention, there is provided a switching power supply apparatus including; a first switching power supply circuit for performing a switching operation based on a first drive signal; a drive signal converter having a transformer which converts the first drive signal to a second drive signal; and a second switching power supply circuit for performing a switching operation based on the second drive signal.

In the switching power supply apparatus according to the present invention, the synchronizing signal is transferred from the first switching power supply circuit to the second switching power supply circuit, with insulation, by the transformer with high speed.

In the first switching power supply circuit, a first controlling unit generates a synchronizing signal and a first drive signal synchronized with the synchronizing signal, and providing the first switch element with the first drive signal, thereby controlling current flow of the first winding of the first transformer.

The second switching power supply circuit is provided with the synchronizing signal generated in the first switching power supply circuit via the transformer in the synchronous circuit. Then, the second switching power supply circuit generates a second drive signal synchronized with the synchronizing signal and providing the same to the second switch element, thereby controlling current flow of the first winding of the second transformer.

Therefore, it becomes possible to control the first and second switch elements synchronously.

According to the present invention, a synchronizing signal, which is required in driving a plurality of switching power supply circuits, is firmly transferred with insulation between the circuits, even if an applied switching frequency is high. Further, the switching power supply apparatus according to the present invention is small and low cost. Therefore, it can be applied for extensive applications.

### BRIEF DESCRIPTION OF THE DRAWINGS

These and other objects and features of the present invention will be described in more detail with reference to the accompanying drawings, in which:

FIG. 1 is a circuit diagram of a switching power supply apparatus according to a first embodiment of the present invention;

FIG. 2 is a circuit diagram of a synchronous circuit according to a second embodiment of the present invention;

FIG. 3 shows waveforms of synchronizing signals applied for a synchronous circuit;

FIG. 4 illustrates an application example of a synchronous circuit according to the third embodiment of the present invention;

FIG. 5 illustrates an application example of a synchronous circuit according to the third embodiment of the present invention; and

FIG. 6 shows a constitution example of a synchronous circuit among a plurality of switching power supply circuits.

### DESCRIPTION OF THE PREFERRED EMBODIMENTS

Below, embodiments of a drive circuit according to the present invention will be described with reference to the attached drawings.

### FIRST EMBODIMENT

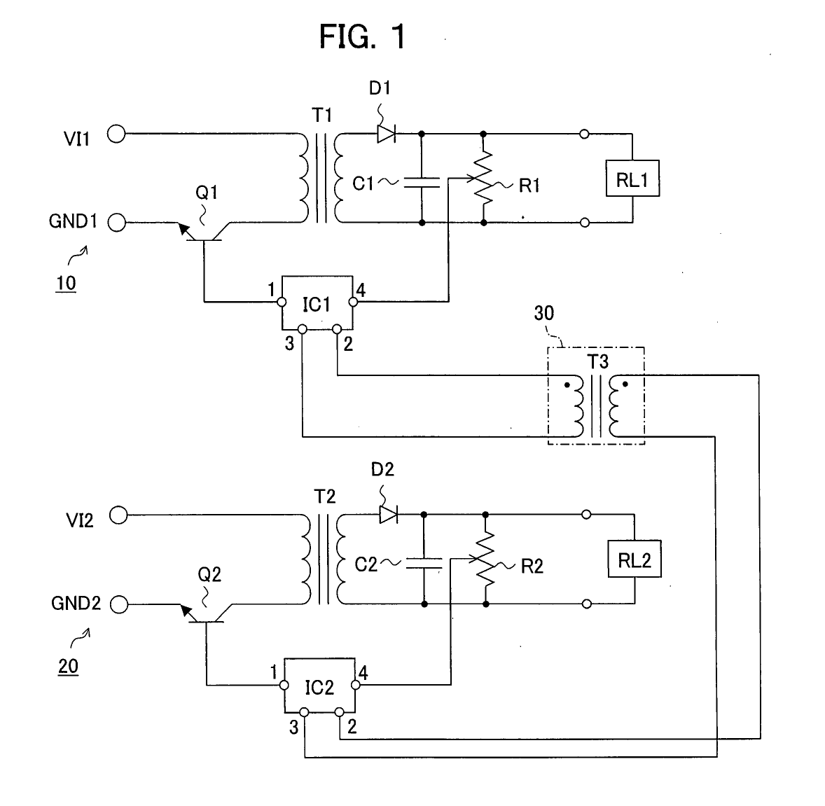

FIG. 1 shows an example of a circuit diagram of a switching power supply apparatus according to a first embodiment of the present invention.

In order to perform a synchronous operation among a plurality of switching power supply circuits that input a DC voltage independently, the switching power supply apparatus has a synchronous circuit for transferring a synchronizing signal among control ICs in the switching power supply circuits. The synchronizing signal is transferred with insulation, thereby reducing noise accompanied by the switching operation.

A constitution of the switching power supply apparatus shown in FIG. 1 will be described below.

As shown in FIG. 1, a switching power supply circuit 10 has a transistor Q1 (first switch element), a control IC1 (first controlling unit), a diode D1, a capacitor C1, and a resistor R1. Its output terminal is connected to a proper load RL1. A switching power supply circuit 20 has a transistor Q2 (second switch element), a control IC2 (second controlling unit), a diode D2, a capacitor C2, and a resistor R2. Its output terminal is connected to a proper load RL2.

The switching power supply circuits 10, 20 are common in constitution. Therefore, the switching power supply circuit 10 will only be described below.

The transistor Q1 in the switching power supply circuits 10 is, as shown, a NPN type bipolar transistor. A PWM drive signal (Pulse Width Modulation signal) is provided to the base from the control IC1, thereby controlling collector current. As a result, in the switching power supply circuit 10, in response to an inputted DC voltage VI1, AC voltage of which effective value depends on a duty ratio of the PWM drive signal, is excited at a secondary winding of a transformer T1.

The diode D1, which is connected in series to the secondary winding of the transformer t1, rectifies the excited AC voltage.

The capacitor C1 smoothes the voltage rectified by the diode D1, thereby eliminating a ripple.

The control IC1 controls an output voltage of the switching power supply circuit 10. It has at least four terminals.

A terminal 1 shown in FIG. 1, as mentioned above, provides the base of the transistor Q1 with the PWM drive signal of which duty ratio is adjustable from the outside. A terminal 2 and a terminal 3 are used to send out a predetermined synchronizing signal via a synchronous circuit 30.

For example, the control IC1 generates a clock pulse as a synchronizing signal and outputs the same via the terminal 2. The terminal 3 of the control IC1 is connected to either a ground potential in the control IC1 or a ground terminal GND1 of the switching power supply circuits 10. The clock pulse as a synchronizing signal is used only to synchronize the PWM drive signal. Therefore, the duty ratio of the clock pulse may be much smaller than that of the PWM drive signal. It is a several percent for example.

A terminal 4 is connected to the resistor R1 that is on a secondary side of the transformer T1.

The control IC1 detects a DC voltage that appears on the secondary side of the transformer T1 and feedbacks the same, thereby controlling the duty ratio of the PWM drive signal provided to the transistor Q1 from the terminal 1. Consequently, the output voltage on the secondary side of the transformer T1 is stabilized.

The control IC2 in the switching power supply circuit 20 differs from the control IC1 in the switching power supply circuit 10, in that it does not generate a synchronizing signal by itself and controls based on a synchronizing signal provided from the control IC1.

Concretely, the control IC2 inputs the synchronizing signal, which is provided from the control IC1, from the terminal 2 via the transformer T3. The terminal 3 of the control IC2 is connected to either a ground potential in the control IC2 or a ground terminal GND2 of the switching power supply circuits 20.

Being insulated due to the transformer T3, the synchronizing signal is provided to the control IC2. Voltage amplitude of a clock pulse as the synchronizing signal may be adjusted by winding ratio of a primary winding Np and a secondary winding Ns. Therefore, the voltage amplitude of the clock pulse is variable, depending on a specification of the control IC2.

As mentioned above, the synchronous circuit 30 includes the transformer T3 having the primary winding Np and the secondary winding Ns.

The synchronous circuit 30 provides the control IC2 with the synchronizing signal outputted from the control IC1, insulating the same. Several volts amplitude is sufficient for the clock pulse as the synchronizing signal, which makes the transformer T3 very small. Accordingly, it is possible to mount the transformer T3 on an electrical circuit board.

The clock pulse, which is the synchronizing signal for a reference of the PWM drive signal provided from the control IC1 to transistor Q1, is transferred via the synchronous circuit 30 to the control IC2 with insulation. The control IC2 provides the transistor Q2 with a PWM drive signal, synchronizing with the transferred clock pulse.

As explained above, in the switching power supply apparatus according to the present embodiment, the control IC1 in the switching power supply circuit 10 controls the transistor Q1 based on the PWM drive signal provided from the control IC1. Then, a voltage, of which effective value depends on the duty ratio of the PWM drive signal, is obtained on the secondary side of the transformer T1. In a similar manner, the control IC2 in the switching power supply circuit 20 controls the transistor Q2 based on the PWM drive signal provided from the control IC2. Then, a voltage, of which effective value depends on the duty ratio of the PWM drive signal, is obtained on the secondary side of the transformer T2.

At this time, the control IC2 synchronizes the PWM drive signal with the synchronizing signal that is provided from the control IC1 with insulation via the transformer T3, and provides the PWM drive signal to the transistor Q2. Therefore, it becomes possible to completely match operation timing for switching in the switching power supply circuits 10, 20.

Moreover, in the switching power supply apparatus according to the present embodiment, amplitude of the synchronizing signal can be set to a desired value by. adjusting winding ratio of the primary winding Np and the secondary winding Ns. Therefore, it becomes possible to set the amplitude of the synchronizing signal to a value according to the specification of the control IC.

The switching power supply apparatus according to the present embodiment transfers the synchronizing signal via the transformer T3. Therefore, it becomes operable under extensive switching frequency range from several 10 KHz to several 1000 KHz. The duty ratio of the synchronizing signal is so small that the transformer can be reset by adjusting input impedance on a receiving side of the synchronizing signal, without using an additional part for resetting the transformer.

Moreover, the voltage amplitude of the clock pulse as the synchronizing signal is several volts level and the pulse width is from several ns to several 100 ns. Therefore, power dissipation by the transformer T3 in the synchronous circuit 30 is almost nothing, which makes the transformer T3 very small. Consequently, it becomes possible to mount the transformer on a circuit board, thereby reducing the cost.

### SECOND EMBODIMENT

Next, a synchronous circuit of switching apparatus according to the second embodiment will be described.

The synchronous circuit of the switching apparatus according to the present embodiment generalizes the synchronous circuit according to the first embodiment. That is, the synchronous circuit 30 according to the first embodiment may be applicable almost all switching power supply apparatuses that control switching by control ICs, irrespective of the constitution of the above switching power supply circuits 10, 20.

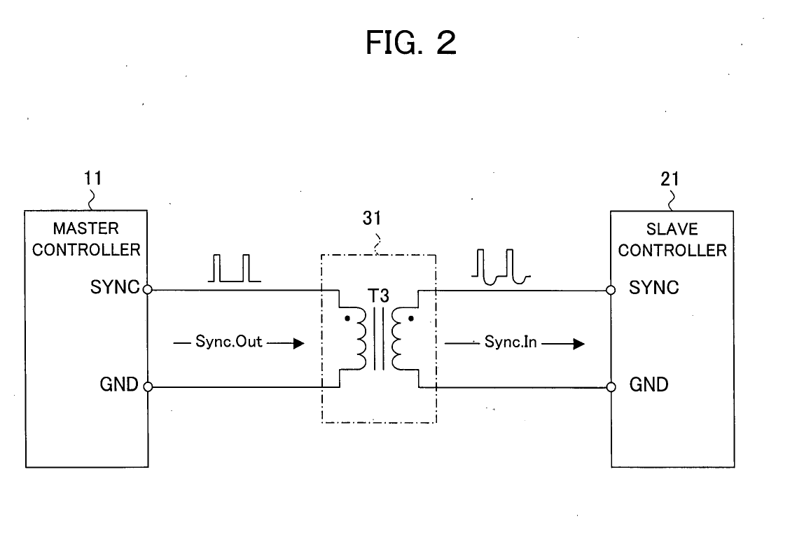

FIG. 2 is a circuit diagram of a synchronous circuit according to a second embodiment of the present invention.

In FIG. 2, a master controller (MASTER CONTROLLER) 11 and a slave controller (SLAVE CONTROLLER) 21 correspond to the control IC1 and the control IC2 respectively in the first embodiment. They control drive signals for switching. Namely, each controller sends out a signal (drive signal), which is used for controlling timing of switching in a switching power supply apparatus, to a controlled object.

The master controller 11 sends out the above drive signal to a controlled object (not shown). It also generates a clock pulse that is the synchronizing signal of a timing reference for the drive signal output, and outputs the same from a synchronization terminal SYNC (Sync.Out).

The slave controller 21 also sends out a drive signal to a controlled object (not shown) in a similar manner. However, the slave controller does not generate the drive signal by itself. As shown in FIG. 2, it sends out the drive signal via a synchronous circuit 31 including a transformer T3, being synchronized with the synchronizing signal provided from the master controller 11 (Sync.In).

The master controller 11 and the slave controller 21 are grounded independently to each ground terminal GND, and they are electrically insulated completely.

With the above constitution, the synchronous circuit of switching apparatus according to the present embodiment has the following advantageous effects in a like manner as the switching power supply apparatus according to the first embodiment. That is, it becomes possible: to completely match operation timing for switching in the master controller 11 and the slave controller 21; to operate with a extensively ranged switching frequency signal; and to realize minimization and low cost.

### THIRD EMBODIMENT

Next, an application example will be the described of synchronous circuit of switching apparatus according to the second embodiment.

In the second embodiment, the case was described in which a synchronizing signal transferred between the master controller 11 and the slave controller 21 was a clock pulse, with reference to FIG. 2. However, in reality, there is the case in which synchronization systems are different in controllers, and accordingly synchronizing signals applicable to the controllers are different.

A synchronous circuit of switching apparatus according to the present embodiment differs from the above synchronous circuit of switching apparatus in the second embodiment, in that a signal converter is added to adapt a difference of synchronizing signals of controllers.

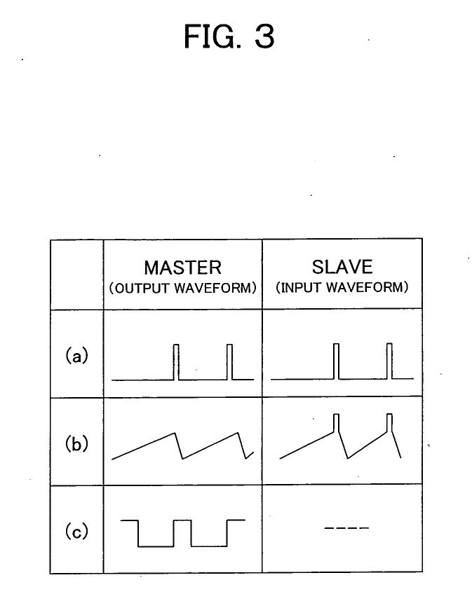

FIG. 3 shows waveforms of synchronizing signals transferring between a master controller and a slave controller in which: (a) shows a clock synchronization system; (b) shows a ramp synchronization system; and (c) shows a PWM drive output synchronization system.

In the clock synchronization system ((a) in FIG. 3), a clock pulse for synchronization is outputted from a synchronization terminal SYNC of the master controller, in a similar manner to the synchronous circuits that is described in the first and second embodiments.

As already described, voltage amplitude of the clock pulse is several volts, and its duty ratio is merely a several percent.

In the ramp synchronization system ((b) in FIG. 3), a master controller sends out a synchronizing signal forming a sawtooth waveform, which synchronizes an operation in a slave controller.

In the PWM drive output synchronization system ((c) in FIG. 3), as described, a slave controller is directly synchronized by a PWM drive signal. Therefore, a signal converter for a synchronizing signal is not required.

Below, a synchronous circuit of switching power supply apparatus will be described further having a signal converter that converts a drive signal between controllers in which a clock or ramp synchronization system is applied.

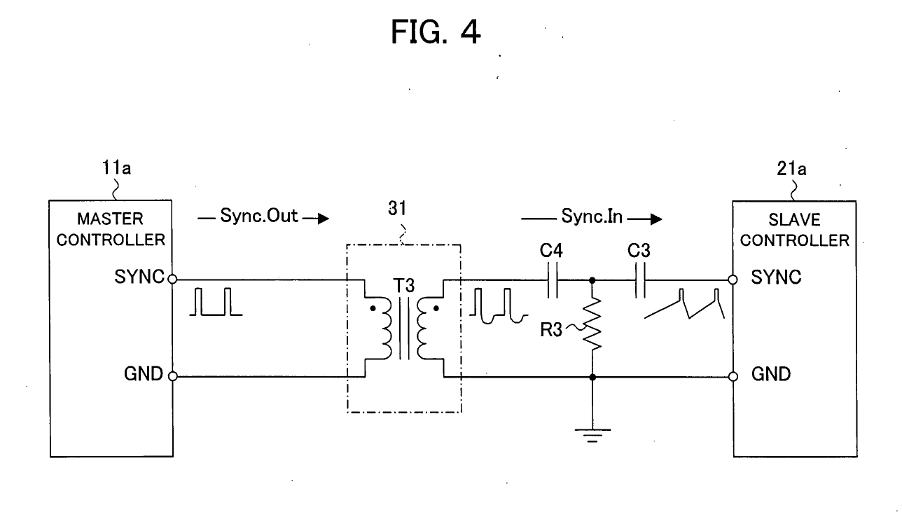

FIG. 4 illustrates a constitution example of a synchronous circuit of switching power supply apparatus, having a signal converter that converts a clock synchronizing signal to a ramp synchronizing signal.

In the synchronous circuit shown in FIG. 4, a clock pulse, which is provided from a synchronization terminal SYNC in a master controller 11a, is transferred with insulation by a transformer T3 in a synchronous circuit 31.

A signal converter having a resistor R3 and a capacitor C3, C4 is an integrating circuit that converts a clock pulse signal excited on a secondary side of the transformer T3 to a sawtooth signal.

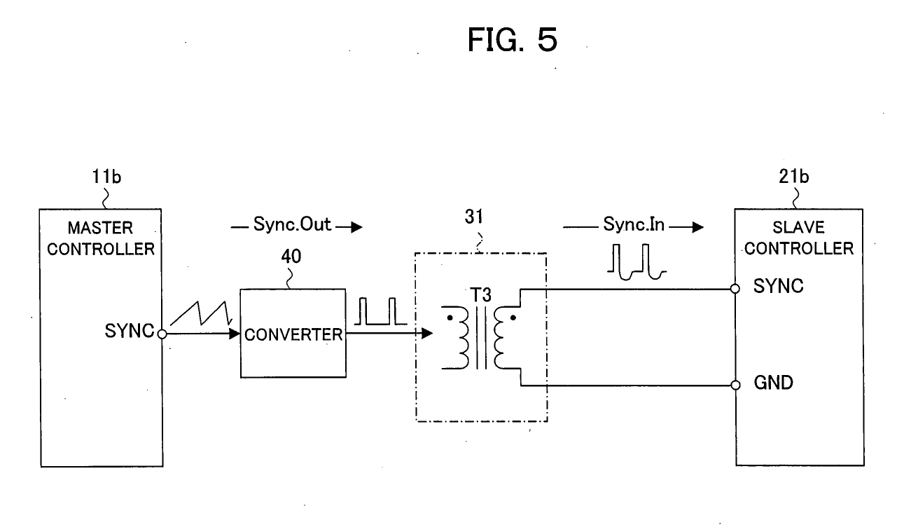

FIG. 5 illustrates a constitution example of a synchronous circuit of switching power supply apparatus, having a signal converter that converts a ramp synchronizing signal to a clock synchronizing signal.

In the synchronous circuit shown in FIG. 5, a signal converter 40 is provided on a master controller side to the synchronous circuit 31. The signal converter 40 converts a ramp signal to a clock signal. It includes a CR differentiating circuit for example.

The synchronous circuit 31 transfers, with insulation, a clock pulse generated by the signal converter 40 to a slave controller 21b connected on the secondary side of the transfer T3, in-a similar-manner to the second embodiment.

Note that a signal converter is not required if a ramp synchronization system is applied for both a master controller and a slave controller. A signal converter may be provided, on a master controller side to the synchronous circuit 31, which converts a PWM drive signal from a master controller to a signal applicable to a slave controller having a clock or a ramp synchronization system.

As explained above, even if different types of synchronizing signals are applied for a master controller and a slave controller, adding a signal converter, if required, enables to synchronize operations in the controllers, changing a synchronizing signal waveform. Therefore, it becomes possible to apply a synchronous circuit having a transformer to extensive control circuit (control IC) applications.

It should be understood by those skilled in the art that various modifications, combinations, subcombinations and alternations may occur depending on design requirements and other factors insofar as they are within the scope of the appended claims or the equivalent thereof.

For example, one to one transfer of a synchronizing signal between control ICs was described in the synchronous circuit of switching apparatus according to the first embodiment. Similarly, a plurality of secondary windings of the transformer in the synchronous circuit may be provided, thereby transferring a synchronizing signal to a plurality of control ICs.

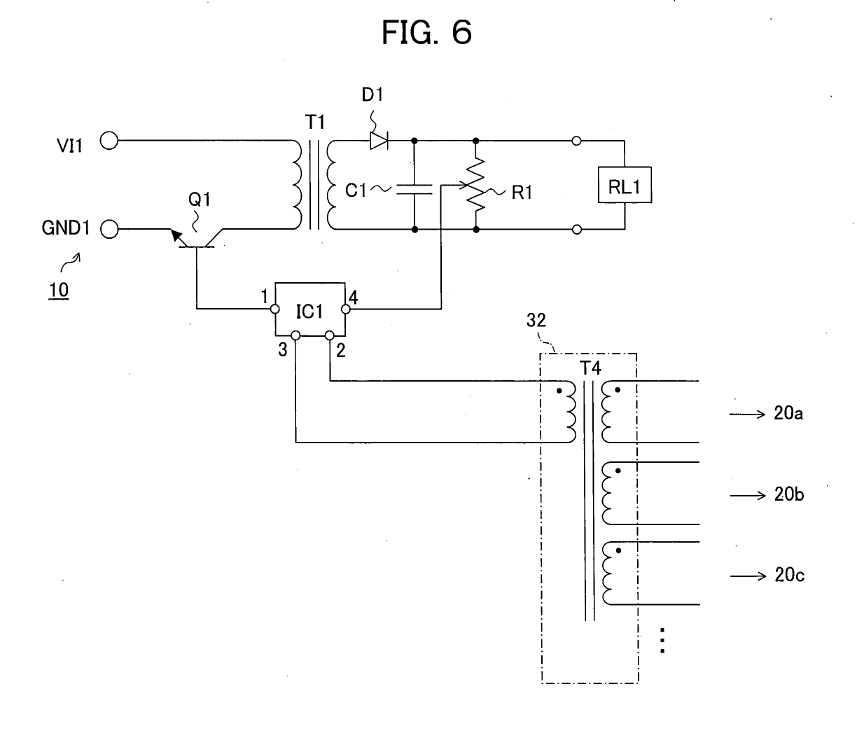

FIG. 6 illustrated a constitution example in which a synchronizing signal is transferred from one switching power supply circuit to the other switching power supply circuits.

In FIG. 6, switching power supply circuits 20a, 20b, 20c have an independent control IC respectively. Each control IC is provided with a synchronizing signal simultaneously from a control IC1 via a transformer T4 in a synchronous circuit 32. This allows the switching power supply circuits 10, 20a, 20b, 20c to be operated synchronously.

Furthermore, one slave controller was described to which a synchronizing signal is given in the synchronous circuit of switching apparatus according to the second embodiment. Similarly, a plurality of secondary windings of the transformer in the synchronous circuit may be provided, thereby transferring a synchronizing signal to not only one slave controller but a plurality of slave controllers.

The synchronous circuit in FIG. 1 transfers a synchronizing signal between the control ICs in the switching power supply circuits in order to synchronously operate the witching power supply circuits that input DC voltage independently. In FIG. 1, the transistor is connected on the primary side of the transformer. Then, the transistor may be connected on the secondary side of the transformer, and be controlled based on a common DC voltage for the switching power supply circuits.

1. A switching power supply apparatus comprising:
a first switching power supply circuit for performing a switching operation based on a first drive signal;
a second switching power supply circuit for performing a switching operation based on a second drive signal; and
a synchronous circuit having a transformer,
wherein a synchronizing signal, which is a reference signal for the drive signals, is generated in one of the first switching power supply circuit and the second switching power supply circuit, and transferred to the other switching power supply circuit via the transformer.

2. A switching power supply apparatus as set forth in claim 1, wherein
the first switching power supply circuit comprises:
a first transformer;
a first switch element connected in series to a first winding of the first transformer; and
a first controlling unit for generating a synchronizing signal and the first drive signal synchronized with the synchronizing signal, and providing the first switch element with the first drive signal, thereby controlling current flow of the first winding of the first transformer,
the second switching power supply circuit comprises:
a second transformer;
a second switch element connected in series to a first winding of the second transformer; and
a second controlling unit for generating the second drive signal synchronized with said synchronizing signal and providing the second switch element with the second drive signal, thereby controlling current flow of the first winding of the second transformer.

3. A switching power supply apparatus as set forth in claim 2 wherein:
the first switching power supply circuit generates the first drive signal synchronized with a first synchronizing signal;
the second switching power supply circuit generates the second drive signal synchronized with a second synchronizing signal which differs from the first synchronizing signal; and
the synchronous circuit has a signal converter for converting the first synchronizing signal to the second synchronizing signal.

4. A switching power supply apparatus as set forth in claim 3 wherein a winding ratio of the first and second winding of said transformer is adjusted so that desired amplitude of the second synchronizing signal is obtained.

5. A switching power supply apparatus comprising;
a first switching power supply circuit for performing a switching operation based on a first drive signal;
a drive signal converter having a transformer which converts the first drive signal to a second drive signal; and
a second switching power supply circuit for performing a switching operation based on the second drive signal.
